(19) United States
(12) Patent Application Publication
(10) Pub. No.: US 2005/0099137 A1
(43) Pub. Date: May 12, 2005

(54) Surface light source, display apparatus having the same and liquid crystal display apparatus having the same

(76) Inventors: Hae-Il Park, Seoul (KR); Hong-Koo Baik, Seoul (KR); Tae-Il Lee, Seoul (KR); Sang-Yu Lee, Yongin-si (KR); Jin-Seob Byun, Seoul (KR)

Correspondence Address: CANTOR COLBURN LLP, 55 Griffin Road South, Bloomfield, CT, 06002, US

(21) Appl. No.: 10/965,567

(22) Filed: Oct. 14, 2004

(30) Foreign Application Priority Data
Nov. 10, 2003 (KR) 2003-79255

(51) Int. Cl. H05B 37/00

(52) U.S. Cl. 315/160; 315/167; 315/169.4

(57) ABSTRACT

In a surface light source, a display apparatus having the surface light source and a liquid crystal display apparatus having the surface light source, the surface light source includes a body, a voltage supplying unit, a conductive body and a visible light generating part. The body includes a plurality of discharge portions. The voltage supplying unit is disposed on an outer surface of the body to generate an invisible light. The conductive body is disposed on an inner surface of the body corresponding to the voltage supplying unit. The visible light generating part is disposed in the discharge portions to generate a visible light based on the invisible light. Therefore, a luminance of the visible light is increased and uniformized. In addition, a start voltage of the surface light source is decreased so that a power consumption of the surface light source may be decreased.

### CROSS-REFERENCE OF RELATED APPLICATION

The present application claims priority from Korean Patent Application No. 2003-79255, filed on Nov. 10, 2003, the disclosure of which is hereby incorporated herein by reference in its entirety.

### BACKGROUND OF THE INVENTION

1. Field of the Invention

The present invention relates to a surface light source, a display apparatus having the surface light source and a liquid crystal display apparatus having the surface light source. More particularly, the present invention relates to a surface light source capable of improving a luminance and a uniformity of the luminance, a display apparatus having the light source and a liquid crystal display apparatus having the surface light source.

2. Description of the Related Art

A display apparatus, generally, displays an image using data that is processed by an information processing device. The display apparatus is classified into a cathode ray tube (CRT), a plasma display panel (PDP), a liquid crystal display (LCD) apparatus, an organic light emitting display (OLED) apparatus, etc. The LCD apparatus displays the image using a liquid crystal.

In the LCD apparatus, an arrangement of the liquid crystal varies in response to an electric field applied thereto, and a light transmittance thereof may be changed.

That is, the LCD apparatus displays the image using electric characteristics and optical characteristics of the liquid crystal. The LCD apparatus is smaller and lighter than the CRT. Various electronic apparatuses, for example, such as a potable computer, a communication equipment, a television receiver set, an aerospace device, etc., include the LCD apparatus.

A conventional LCD apparatus includes a liquid crystal controlling part that controls the liquid crystal and a light supplying part that supplies the liquid crystal controlling part with a light.

The liquid crystal controlling part includes a pixel electrode formed on a first substrate, a common electrode formed on a second substrate and the liquid crystal disposed between the pixel electrode and the common electrode. The liquid crystal controlling part includes a plurality of the pixel electrodes. A number of the pixel electrodes corresponds to a resolution of the LCD apparatus. The common electrode is disposed at a position corresponding to the pixel electrodes. A plurality of thin film transistors (TFT) is electrically connected to the pixel electrodes to apply pixel voltages to the pixel electrodes, respectively. The pixel voltages may be different from one another. A reference voltage is applied to the common voltage. The pixel electrode and the common electrode of the LCD apparatus include a transparent conductive material, for example, such as indium tin oxide (ITO), indium zinc oxide (IZO), zinc oxide (ZO), etc.

The light supplying part supplies the liquid crystal controlling part with the light. The light successively passes through the pixel electrode, the liquid crystal and the common electrode so that the liquid crystal controlling part displays the image. When a uniformity of the luminance of the light is increased, an image display quality of the LCD apparatus is also increased.

The light supplying part of the LCD apparatus includes a cold cathode fluorescent lamp (CCFL) or a light emitting diode (LED). The CCFL has various characteristics, for example, such as high luminance, high efficiency, long lifetime, thin thickness, light weight, low cost and so on. The CCFL also generates a small amount of heat compared to an incandescent lamp. The LED has low power consumption and high luminance.

The CCFL and the LED, however, have non-uniform luminance.

Therefore, the light supplying part having the CCFL includes optical members, for example, such as a light guide panel (LGP), a light diffusion member, a prism sheet, etc., to improve the uniformity of the light.

When the light supplying part includes the optical members, the size and the weight of the LCD apparatus increase.

### BRIEF SUMMARY OF THE INVENTION

The present invention provides a surface light source capable of improving a luminance and a uniformity of the luminance.

The present invention also provides a display apparatus having the above-mentioned surface light source.

The present invention also provides a liquid crystal display apparatus having the above-mentioned surface light source.

In accordance with an aspect of the present invention, a surface light source includes a body, a voltage supplying unit, a conductive body and a visible light generating part. The body includes a plurality of discharge portions. The voltage supplying unit is disposed on an outer surface of the body to generate an invisible light in the discharge portions. The conductive body is disposed on an inner surface of the body corresponding to the voltage supplying unit. The visible light generating part is disposed in the discharge portions to generate a visible light based on the invisible light.

In accordance with another aspect of the present invention, a surface light source includes a body, a voltage supplying unit, a conductive body and a fluorescent layer. The body includes a plurality of discharge portions having operation gas. The voltage supplying unit is disposed on an outer surface of the body to generate an electric field in the discharge portions. The conductive body is disposed on an inner surface of the body corresponding to the voltage supplying unit to supply the discharge portions with electrons based on the electric field. The fluorescent layer disposed in the discharge portions to convert an invisible light generated in the discharge portions by the operation gas and the electrons into a visible light.

In accordance with an exemplary embodiment of the present invention, a display apparatus includes a surface light source, a display panel and a receiving container. The surface light source includes a body including a plurality of discharge portions, a voltage supplying unit disposed on an outer surface of the body to generate an invisible light in the discharge portions, a conductive body disposed on an inner surface of the body corresponding to the voltage supplying unit, and a fluorescent layer to convert the invisible light into a visible light. The display panel is disposed on the surface light source to convert the visible light into an image. The receiving container receives the surface light source and the display panel.

In accordance with another exemplary embodiment of the present invention, a liquid crystal display apparatus includes a surface light source, a liquid crystal display panel and a receiving container. The surface light source includes a body including a plurality of discharge portions, a voltage supplying unit disposed on an outer surface of the body to form an electric field in the discharge portions to generate an invisible light in the discharge portions, a conductive body disposed on an inner surface of the body corresponding to the voltage supplying unit, and a fluorescent layer disposed in the discharge portions to convert the invisible light into a visible light. The liquid crystal display panel is disposed on the surface light source to convert the visible light into an image. The liquid crystal display panel includes a liquid crystal disposed between two substrates. The receiving container receives the surface light source and the liquid crystal display panel.

Therefore, the surface light source includes the voltage supplying unit disposed on the outer surface of the body and the conductive body disposed on the inner surface of the body so that a luminance of the visible light is increased and uniformized. In addition, a start voltage of the surface light source is decreased so that a power consumption of the surface light source may be decreased.

### BRIEF DESCRIPTION OF THE DRAWINGS

The above and other advantages of the present invention will become more apparent by describing exemplary embodiments thereof in detail with reference to the accompanying drawings, in which:

FIG. 1 is a partially cut out perspective view showing a surface light source in accordance with an exemplary embodiment of the present invention;

FIG. 2 is a cross-sectional view taken along the line I-I′ shown in FIG. 1;

FIG. 3 is a plan view showing the surface light source shown in FIG. 1;

FIG. 4 is a cross-sectional view showing a surface light source in accordance with another exemplary embodiment of the present invention;

FIG. 5 is a plan view showing the surface light source shown in FIG. 4;

FIG. 6 is a plan view showing a surface light source in accordance with another exemplary embodiment of the present invention;

FIG. 7 is a plan view showing a surface light source in accordance with another exemplary embodiment of the present invention;

FIG. 8 is a plan view showing a surface light source in accordance with another exemplary embodiment of the present invention;

FIG. 9 is an exploded perspective view showing a surface light source in accordance with another exemplary embodiment of the present invention;

FIG. 10 is a cross-sectional view showing the surface light source shown in FIG. 9; and

FIG. 11 is a partially cut out exploded perspective view showing a liquid crystal display apparatus in accordance with an exemplary embodiment.

### DESCRIPTION OF THE EXEMPLARY EMBODIMENTS

It should be understood that the exemplary embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

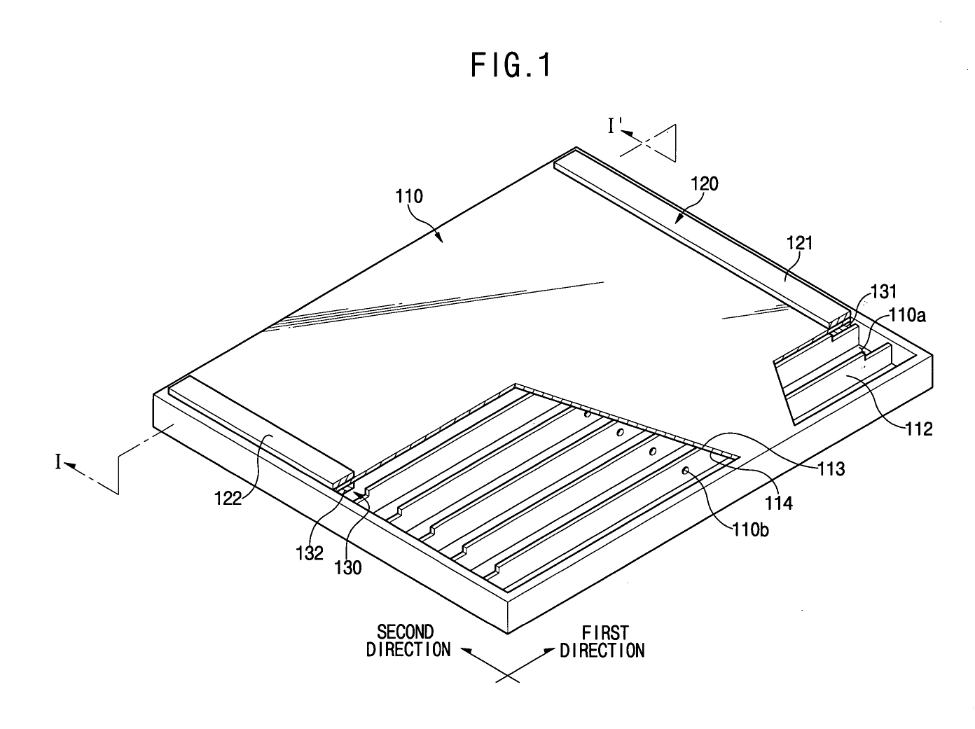

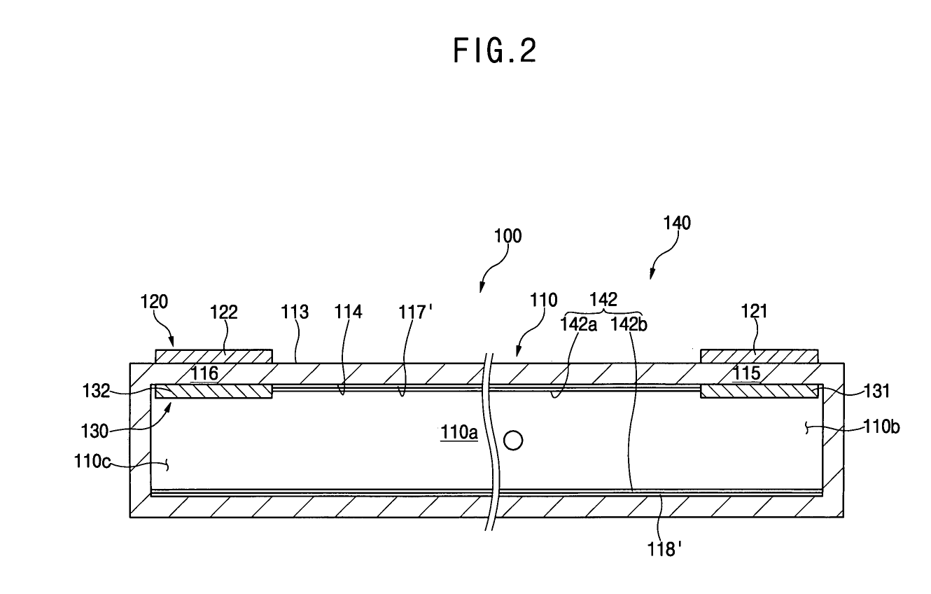

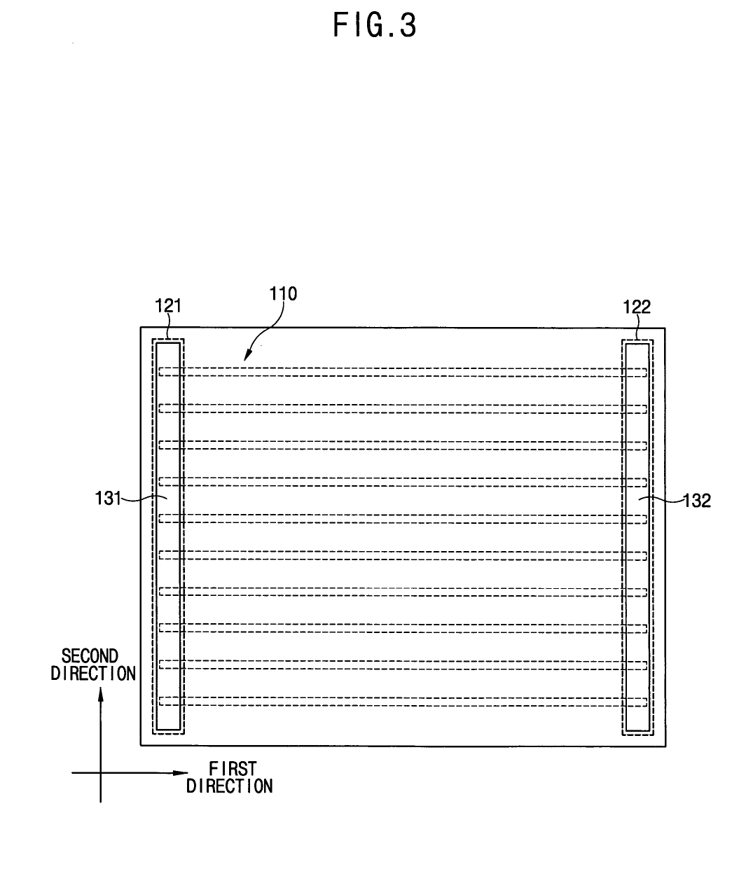

FIG. 1 is a partially cut out perspective view showing a surface light source in accordance with an exemplary embodiment of the present invention. FIG. 2 is a cross-sectional view taken along the line I-I′ shown in FIG. 1. FIG. 3 is a plan view showing the surface light source shown in FIG. 1.

Referring to FIGS. 1 to 3, the surface light source 100 includes a body 110, a voltage supplying unit 120, a conductive body 130 and a visible light generating part 140.

In this exemplary embodiment, the body 110 has a flat hexahedral shape. The body 110 includes a space dividing part 112 therein. Alternatively, the body 110 may include a plurality of the space dividing parts 112. Each of the space dividing parts 112 is extended in a first direction.

A discharge space is disposed in the body 110. The space dividing parts 112 divide the discharge space into a plurality of discharge portions 110a. Each of the discharge portions 110a is extended in the first direction, and the discharge portions 110a are arranged in a second direction that is in substantially perpendicular to the first direction. A connecting portion 110b connects the discharge portions 110a to one another. Alternatively, the discharge portions 110a may be connected by a plurality of the connecting portions 110b.

The body 110 includes a first surface 113 and a second surface 114. The first surface 113 is an outer surface of the body 110. The second surface 114 is an inner surface of the body 110.

The body 110 includes a transparent solid material. Examples of the transparent solid material are glass, triacetylcellulose (TAC), polycarbonate (PC), polyethersulfone (PES), polyethyleneterephthalate (PET), polyethylenenaphthalate (PEN), polyvinylalcohol (PVA), polymethylmethacrylate (PMMA), cyclo-olefin polymer (COP), etc. In this exemplary embodiment, the body 110 includes the glass having a predetermined dielectric constant.

The voltage supplying unit 120 is disposed on the first surface 113 of the body 110. Electrons in the discharge portions 110a are transported by an electric field formed by the voltage supplying unit 120. A first voltage having a first level and a second voltage having a second level are applied to a first end portion 110b and a second end portion 110c of one of the discharge portions by the voltage supplying unit 120, respectively. The second end portion 110c corresponds the first end portion 110b. Therefore, an electric discharge is generated in the discharge portions 110a by a voltage difference between the first and second voltages so that a discharge current flows through the discharge portions 110a.

In this exemplary embodiment, the voltage supplying unit 120 includes a first voltage supplying portion 121 and a second voltage supplying portion 122. The first and second voltage supplying portions 121 and 122 are extended in the second direction so that the first and second voltage supplying portions 121 and 122 are in substantially perpendicular to the discharge portions 110a. The second voltage supplying portion 122 is spaced apart from the first voltage supplying portion 121. The first and second voltage supplying portions 121 and 122 may be in substantially parallel with one another.

The conductive body 130 is disposed on the second surface 114 of the body 110. The conductive body 130 corresponds to the voltage supplying unit 120. The conductive body 130 includes a first conductive portion 131 and a second conductive portion 132.

The first conductive portion 131 corresponds to the first voltage supplying portion 121. The first conductive portion 131 has substantially identical size and shape to the first voltage supplying portion 121. The first conductive portion 131 includes a conductive material, for example, such as metal, indium tin oxide (ITO), indium zinc oxide (IZO), zinc oxide (ZO), etc.

The second conductive portion 132 corresponds to the second voltage supplying portion 122. The second conductive portion 132 has substantially equal size and shape to the second voltage supplying portion 122. The second conductive portion 132 includes the conductive material, for example, such as metal, ITO, IZO, ZO, etc.

The visible light generating part 140 includes an operation gas (not shown), a protecting layer 117′, a reflection layer 118′ and a fluorescent layer 142.

An invisible light is generated in the discharge portions 110a of the lamp 110 by the electric discharge that is generated in the operation gas by the voltage supplying unit 120 and the conductive body 130. The invisible light may be an ultraviolet light. The operation gas includes mercury (Hg), argon (Ar), neon (Ne), xenon (Xe), krypton (K), etc.

The protecting layer 117′ is disposed on the second surface 114 between the body 110 corresponding to a lighting area and the first fluorescent portion 142a of the fluorescent layer 142 to protect the body 110. The lighting area is disposed between the first and second conductive portions 131 and 132. The protecting layer 117′ includes a transparent material. Alternatively, an auxiliary protecting layer (not shown) may be disposed on the second surface 114 between the body 110 and the reflection layer 118′. The protecting layer 117′ may also be omitted.

The reflection layer 118′ corresponds to the protecting layer 117′ so that a light that passes through the second fluorescent portion 142b of the fluorescent layer 142 is reflected from the reflection layer 118′. The reflection layer 118′ includes a highly reflective material. Alternatively, an auxiliary reflection layer (not shown) may be disposed on the second surface 114 corresponding to sides of the body 110 and the space dividing parts.

The fluorescent layer 142 includes a first fluorescent portion 142a disposed on the protecting layer 117′ and a second fluorescent portion 142b disposed on the reflection layer 118′. When the invisible light generated in one of the discharge portions 110a passes through the fluorescent layer 142, a visible light is generated. The fluorescent layer 142 includes a red fluorescent material, a green fluorescent material and a blue fluorescent material. The red, green and blue fluorescent materials are mixed together so that a red light, a green light and a blue light have substantially equal amount to one another. The first voltage having the first level and the second voltage having the second level are applied to the first and second voltage supplying portions 121 and 122, respectively.

An electric charge formed by the first voltage is stored in a portion of the body 110 disposed between the first voltage supplying portion 121 and the first conductive portion 131 so that the level of the first voltage is decreased from the first level to a third level. An electric charge formed by the second voltage is stored in a portion of the body 110 disposed between the second voltage supplying portion 122 and the second conductive portion 132 so that the level of the second voltage is decreased from the second level to a fourth level.

The first voltage having the third level and the second voltage having the fourth level are applied to the first and second conductive portions 131 and 132, respectively.

The electric discharge is generated in one of the discharge portions 110a by the voltage difference formed between the first voltage having the third level and the second voltage having the fourth level so that a portion of the operation gas or the whole operation gas is in a plasma state.

The first and second conductive portions 131 and 132 disposed in the body 110 emit secondary electrons so that a density of the plasma is increased.

When the electric discharge is generated in one of the discharge portions 110a, the secondary electrons are combined with mercury so that the invisible light is generated in the discharge portions 110a.

When the invisible light passes through the fluorescent layer 142, the visible light is generated.

The protecting layer 117′ is disposed on the second surface 114 between the body 110 corresponding to the lighting area and the first fluorescent portion 142a of the fluorescent layer 142 to protect the body 110. The lighting area is disposed between the first and second conductive portions 131 and 132. The reflection layer 118′ corresponds to the protecting layer 117′ so that the visible light that passes through the second fluorescent portion 142b of the fluorescent layer 142 is reflected from the reflection layer 118′.

According to this exemplary embodiment, the voltage supplying unit 120 for generating the plasma is disposed on the exterior to the body 110, and the conductive body 130 for increasing the density of the plasma is disposed on the interior to the body 110 so that a luminance of the visible light generated from the surface light source 100 is increased. In addition, the luminance of the visible light is uniformized.

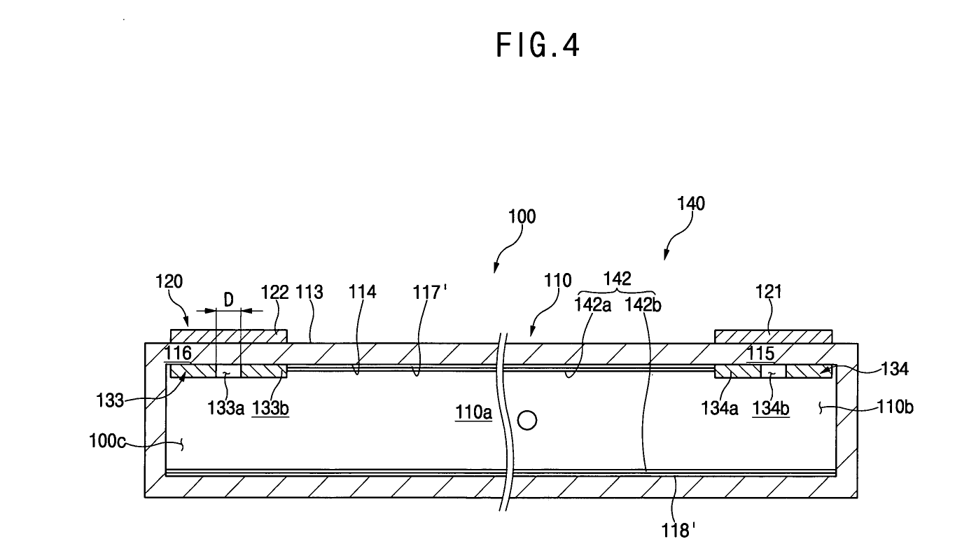

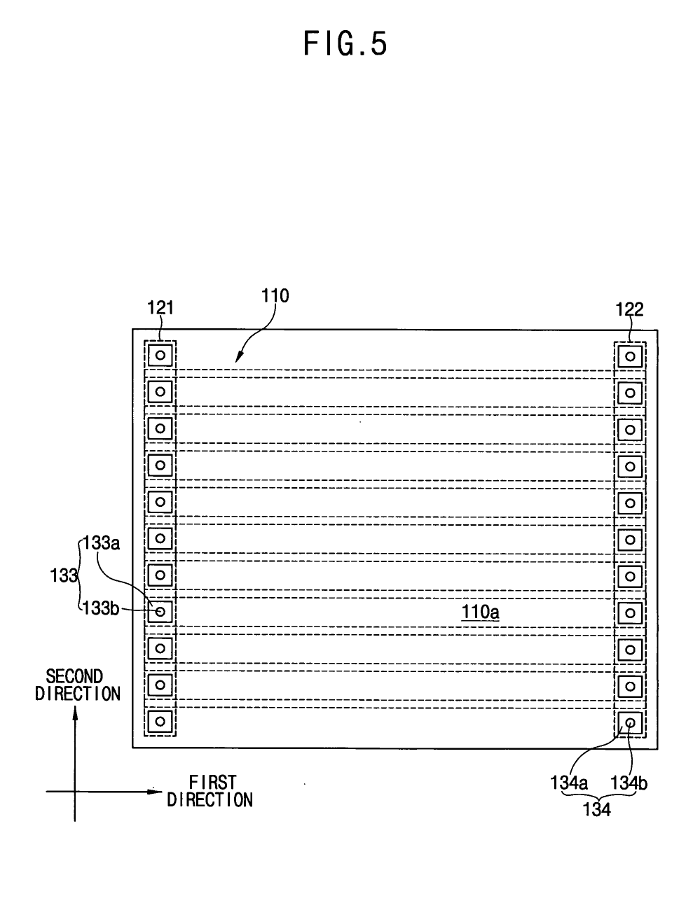

FIG. 4 is a cross-sectional view showing a surface light source in accordance with another exemplary embodiment of the present invention. FIG. 5 is a plan view showing the surface light source shown in FIG. 4. The surface light source shown in FIGS. 4 and 5 is same as in FIGS. 1 to 3 except a conductive body. Thus, the same reference numerals will be used to refer to the same or like parts as those described in FIGS. 1 to 3 and any further explanation concerning the above elements will be omitted.

Referring to FIGS. 4 and 5, the conductive body 130 includes a first conductive portion 133 and a second conductive portion 134.

The first and second conductive portions 133 and 134 have rectangular plate shapes. In this exemplary embodiment, the surface light source includes a plurality of the first conductive portions 133 and a plurality of the second conductive portions 134. The first conductive portions 133 are disposed on a second surface 114 of a body 110 corresponding to a first voltage supplying portion 121. The first conductive portions 133 are arranged along a second direction. The second conductive portions 134 are arranged along the second direction. The second conductive portions 134 are disposed on the second surface 114 of the body 110 corresponding to a second voltage supplying portion 122.

Each of the first conductive portions 133 includes a first conductive body 133a and a first hole 133b. The first hole 133b corresponds one of discharge portions 110a.

Each of the second conductive portions 134 includes a second conductive body 134a and a second hole 134b. The second hole 134b corresponds one of the discharge portions 110a. Alternatively, the first and second conductive portions 133 and 134 may include first and second recesses (not shown).

A first voltage having a first level and a second voltage having a second level are applied to the first and second voltage supplying portions 121 and 122 of a voltage supplying portion 120, respectively.

An electric charge formed by the first voltage is stored in a portion of the body 110 disposed between the first voltage supplying portion 121 and the first conductive portion 133 so that the level of the first voltage is decreased from the first level to a third level. An electric charge formed by the second voltage is stored in a portion of the body 110 disposed between the second voltage supplying portion 122 and the second conductive portion 134 so that the level of the second voltage is decreased from the second level to a fourth level.

The first voltage having the third level and the second voltage having the fourth level are applied to the first and second conductive portions 133 and 134, respectively.

An amount of the electrons supplied to the discharge portions 110a is increased due to a hollow cathode effect in the first hole 133a of the first conductive portion 133.

The electric discharge is generated in one of the discharge portions 110a by the voltage difference formed between the first voltage having the third level and the second voltage having the fourth level so that a portion of the operation gas or the whole operation gas is in a plasma state.

The first conductive portions 133 having the first holes 133b and the second conductive portions 134 having the second holes 134b emit secondary electrons so that a density of the plasma in the body 110 is increased. In addition, an amount of a discharge current in the body 110 is increased.

When the electric discharge is generated in one of the discharge portions 110a, the secondary electrons are combined with mercury so that the invisible light is generated in the discharge portions 110a.

When the invisible light passes through the fluorescent layer 142, the visible light is generated.

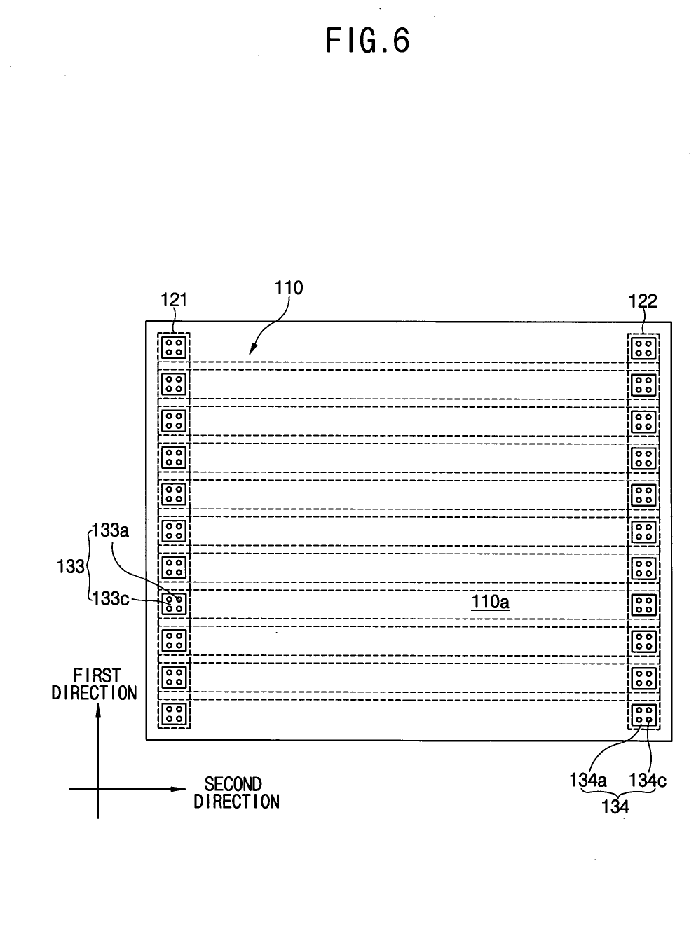

FIG. 6 is a plan view showing a surface light source in accordance with another exemplary embodiment of the present invention.

Referring to FIG. 6, a plurality of third holes 133c is disposed in one of first conductive portions 133, and a plurality of fourth holes 134c is disposed in one of second conductive portions 134.

According to the present embodiment, a density of plasma in a body 110 is increased so that a start voltage is decreased, thereby decreasing a power consumption of the surface light source 100. Therefore, an electric discharge of the surface light source 100 is stabilized. In addition, a luminance of a light generated from the surface light source 100 is increased, and the luminance of the light may be uniformized.

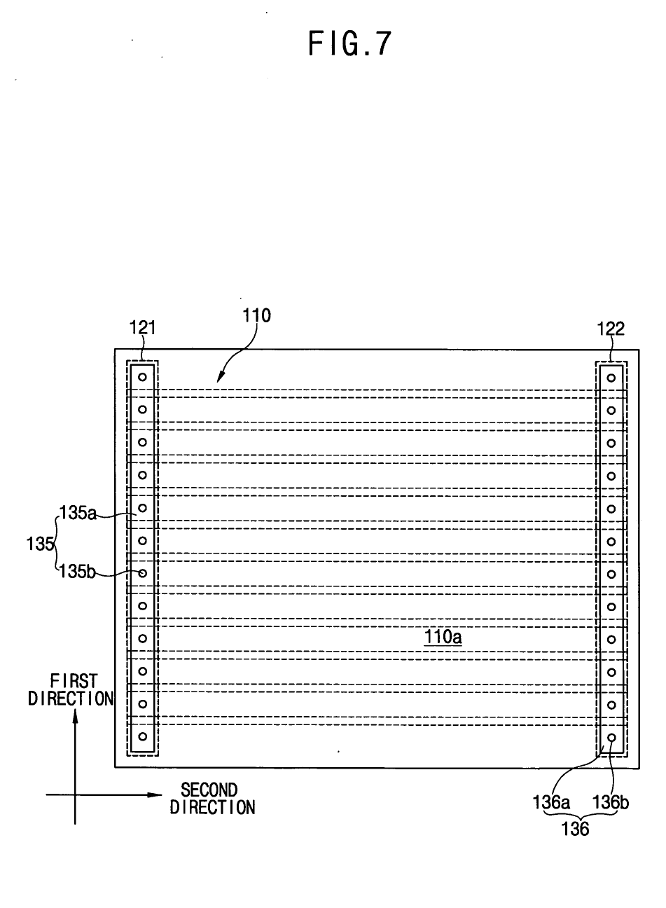

FIG. 7 is a plan view showing a surface light source in accordance with another exemplary embodiment of the present invention. The surface light source shown in FIG. 7 is same as in FIGS. 1 to 3 except a conductive body. Thus, the same reference numerals will be used to refer to the same or like parts as those described in FIGS. 1 to 3 and any further explanation concerning the above elements will be omitted.

Referring to FIG. 7, the conductive body 130 includes a first conductive portion 135 and a second conductive portion 136.

The first and second conductive portions 135 and 136 have rectangular plate shapes. The first and second conductive portions 135 and 136 are extended in a second direction. The second conductive portion 136 is spaced apart from the first conductive portion 135. The first and second conductive portions 135 and 136 correspond to a first voltage supplying portion 121 and a second voltage supplying portion 122, respectively.

The first conductive portion 135 includes a first conductive body 135a and a first hole 135b. Alternatively, the first conductive portion 135 may include a plurality of the first holes 135b. Each of the first holes 135b corresponds to each of discharge portions 110a. Sizes of the first holes 135b are substantially equal to one another. The size of one of the first holes 135b is determined by a density of plasma in a body 110.

The second conductive portion 136 includes a second conductive body 136a and a second hole 136b. Alternatively, the second conductive portion 136 may include a plurality of the second holes 136b. Each of the second holes 136b corresponds to each of the discharge portions 110a. Sizes of the second holes 136b are substantially equal to one another. The size of one of the second holes 136b is determined by the density of the plasma in the body 110.

A first voltage having a first level and a second voltage having a second level are applied to the first and second voltage supplying portions 121 and 122, respectively.

An electric charge formed by the first voltage is stored in a portion of the body 110 disposed between the first voltage supplying portion 121 and the first conductive portion 135 so that the level of the first voltage is decreased from the first level to a third level. An electric charge formed by the second voltage is stored in a portion of the body 110 disposed between the second voltage supplying portion 122 and the second conductive portion 136 so that the level of the second voltage is decreased from the second level to a fourth level.

The first voltage having the third level and the second voltage having the fourth level are applied to the first and second conductive portions 135 and 136, respectively.

An amount of the electrons supplied to the discharge portions 110a is increased due to a hollow cathode effect in the first holes 135a of the first conductive portion 135.

The electric discharge is generated in one of the discharge portions 110a by the voltage difference formed between the first voltage having the third level and the second voltage having the fourth level so that a portion of the operation gas or the whole operation gas is in a plasma state.

The first conductive portion 135 having the first holes 135b and the second conductive portion 136 having the second holes 136b emit secondary electrons so that a density of the plasma is increased.

When the electric discharge is generated in one of the discharge portions 110a, the secondary electrons are combined with mercury so that an invisible light is generated in the discharge portions 110a.

When the invisible light passes through a fluorescent layer 142, a visible light is generated.

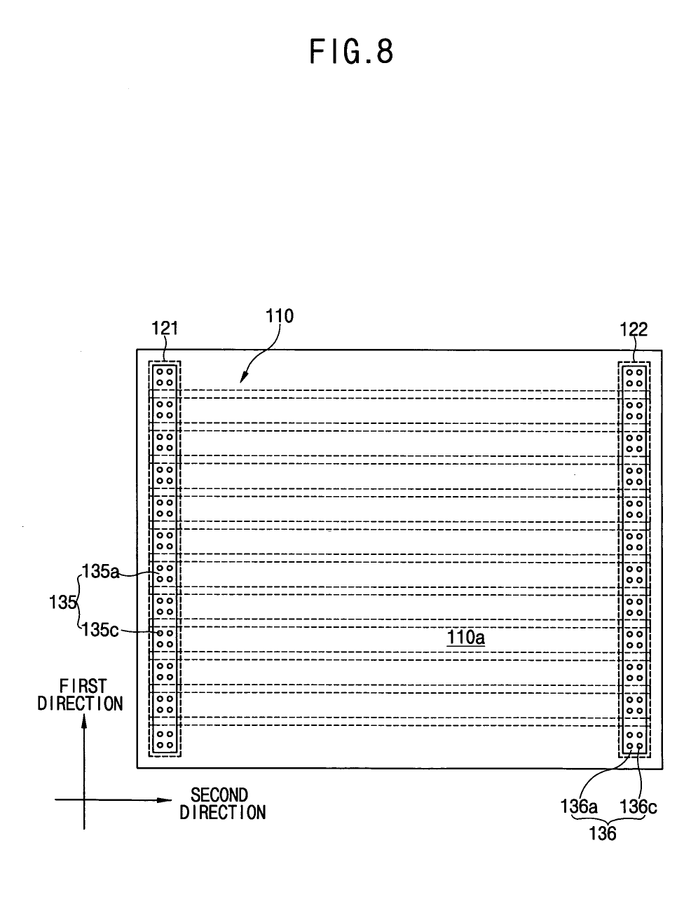

FIG. 8 is a plan view showing a surface light source in accordance with another exemplary embodiment of the present invention.

Referring to FIG. 8, a first conductive portion 135 corresponding to one of discharge portions 110a has a plurality of third holes 135c, and a second conductive portion 136 corresponding to one of the discharge portions 110a has a plurality of fourth holes 136c.

According to this exemplary embodiment, a density of plasma in a body 110 is increased so that a start voltage is decreased, thereby decreasing a power consumption of the surface light source 100. Therefore, a luminance of a light generated from the surface light source 100 is increased, and the luminance of the light may be uniformized.

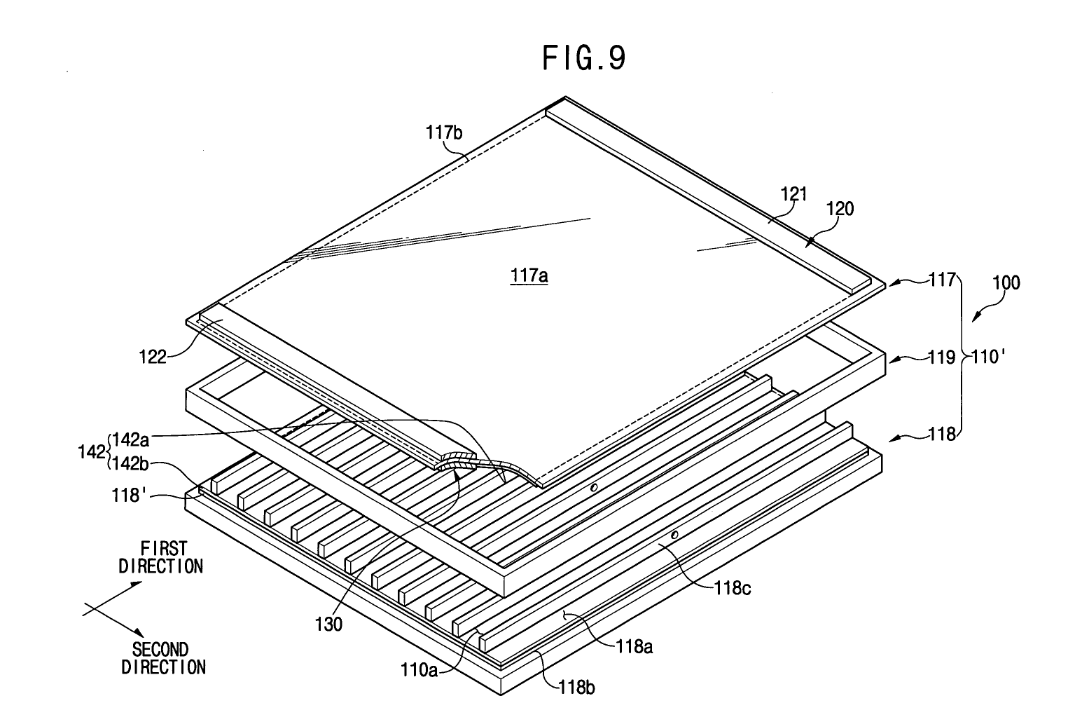

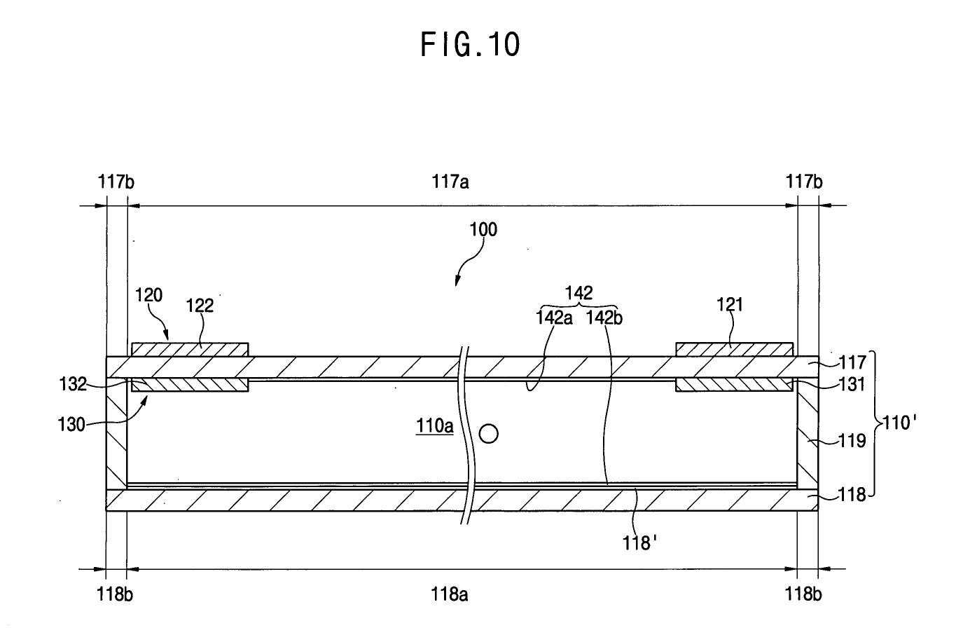

FIG. 9 is an exploded perspective view showing a surface light source in accordance with another exemplary embodiment of the present invention. FIG. 10 is a cross-sectional view showing the surface light source shown in FIG. 9. The surface light source shown in FIGS. 9 and 10 is same as in FIGS. 1 to 3 except a body. Thus, the same reference numerals will be used to refer to the same or like parts as those described in FIGS. 1 to 3 and any further explanation concerning the above elements will be omitted.

Referring to FIGS. 9 and 10, the surface light source 100 includes the body 110′, a space dividing member 118c, a fluorescent layer 142 and a reflection layer 118′. The surface light source 100 may include a plurality of the space dividing members 118c.

A discharge space is formed in the body 110′. In this exemplary embodiment, the body 110′ includes a first substrate 117, a second substrate 118 and a sealant 119.

In this exemplary embodiment, a visible light may pass through the first substrate 117, whereas an ultraviolet light may not pass through the first substrate 117. The first substrate 117 includes a first central region 117a and a first peripheral region 117b that surrounds the first central region 117a.

The second substrate 118 corresponds to the first substrate 117. In this exemplary embodiment, the second substrate 118 has a substantially same material as the first substrate 117 so that the visible light may pass through the second substrate 118 and the ultraviolet light may not pass through the second substrate 118. The second substrate includes a second central region 118a and a second peripheral region 118b that surrounds the first substrate 118a.

The second central region 118a and the second peripheral region 118b correspond the first central region 117a and the first peripheral region 117b, respectively.

The sealant 119 is disposed between the first peripheral region 117b of the first substrate 117 and the second peripheral region 118b of the second substrate 118. The sealant 119 has a rectangular frame shape so as to have substantially identical size and shape to the first peripheral region 117b and the second peripheral region 118b.

The second substrate 118 is combined with the first substrate 117 using the sealant 119 so that the first peripheral region 117b of the first substrate 117 corresponds to the second peripheral region 118b of the second substrate 118. A thermal conductivity of the sealant 119 is substantially identical to a thermal conductivity of the first substrate 117 and a thermal conductivity of the second substrate 118 so as to prevent thermal deformations of the first and second substrates 117 and 118, respectively.

The space dividing members 118c are disposed in the body 110′ to divide the discharge space into a plurality of discharge portions 110a so that a power consumption of the surface light source 100 may be decreased.

The space dividing members 118c are disposed between the first central region 117a of the first substrate 117 and the second central region 118a of the second substrate 118. Each of the space dividing members 118c is extended in a first direction, and the space dividing members 118c are aligned in a second direction that is in substantially perpendicular to the first direction. Each of the space dividing members 118c has a hexahedral shape extended in the second direction. In addition, one of the space dividing members 118c has a transparent synthetic resin or a glass. Alternatively, one of the space dividing members 118c may include an opaque synthetic resin.

The discharge portions 110a are connected to one another through a connecting portion. Alternatively, the discharge portions 110a may be connected to one another through a plurality of the connecting portions.

The reflection layer 118′ is disposed on an upper surface of the second substrate 117 so that the visible light generated in a second fluorescent portion 142b of the fluorescent layer 142 is reflected from the reflection layer 118′. The reflection layer 118′ includes a metal having high reflectivity.

The fluorescent layer 142 includes a first fluorescent portion 142a disposed on the first substrate 117 and the second fluorescent portion 142b disposed on the reflection layer 118′. The first fluorescent portion 142a corresponds to the second fluorescent portion 142b. When the invisible light passes through the fluorescent layer 142, the visible light is generated. The fluorescent layer 142 includes a red fluorescent material, a green fluorescent material and a blue fluorescent material. The red, green and blue fluorescent materials are mixed to one another so that a red light, a green light and a blue light have substantially equal amount to one another.

The space dividing members 118c divide the discharge space into a plurality of discharge portions 110a so that a start voltage is decreased, thereby decreasing a power consumption of the surface light source 100.

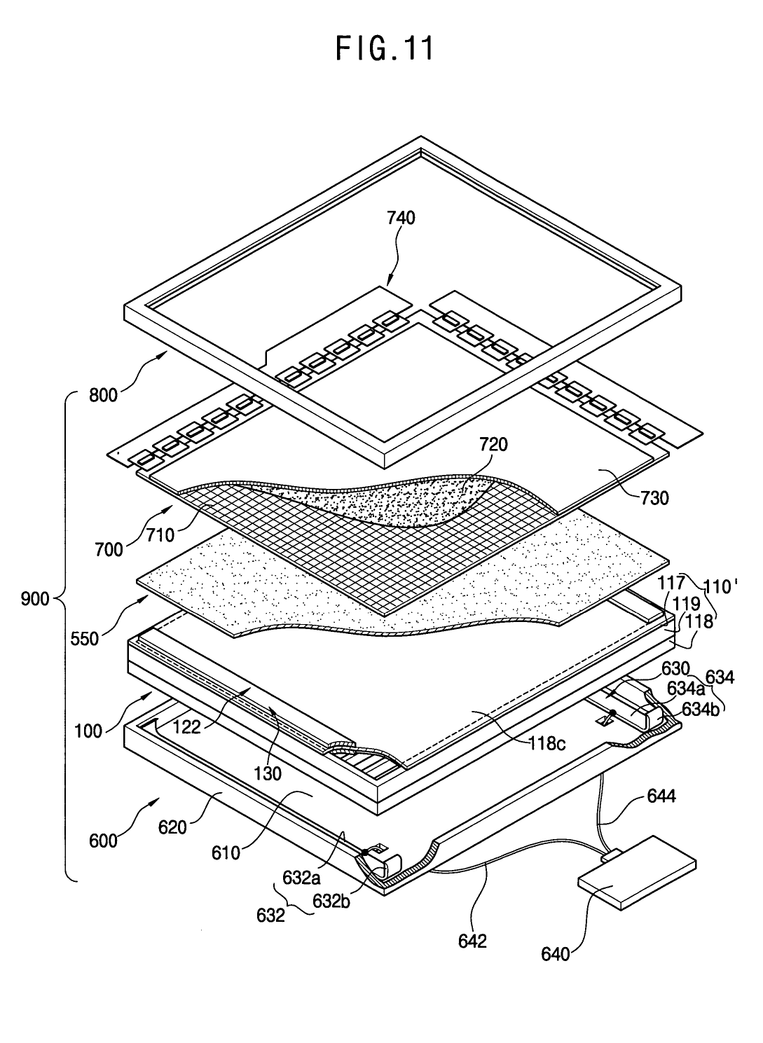

FIG. 11 is a partially cut out exploded perspective view showing a liquid crystal display apparatus in accordance with an exemplary embodiment. A surface light source of the liquid crystal display (LCD) apparatus, which is shown in FIG. 11, is same as in FIGS. 9 to 10. Thus, the same reference numerals will be used to refer to the same or like parts as those described in FIGS. 9 to 10 and any further explanation concerning the above elements will be omitted.

Referring to FIG. 11, the LCD apparatus 900 includes a receiving container 600, the surface light source 100, an LCD panel 700 and a chassis 800.

The receiving container 600 includes a bottom plate 610, a plurality of sidewalls 620 that are protruded from sides of the bottom plate 610 to form a receiving space, a discharge voltage applying module 630 and an inverter 640. The receiving container 600 prevents a drifting of the surface light source 100 and the LCD panel 700.

The surface light source 100 is disposed on the bottom plate 610. The bottom plate 610 has a substantially identical shape to the surface light source 100. In this exemplary embodiment, the bottom plate 610 and the surface light source 100 have hexahedral plate shapes.

The sidewalls 620 prevent a drifting of the surface light source 100.

The discharge voltage applying module 630 applies a discharge voltage to a voltage supplying unit 130 of the surface light source 100. The discharge voltage applying module 630 includes a first discharge voltage applying portion 632 and a second discharge voltage applying portion 634. The first discharge voltage applying portion 632 includes a first clip body 632a and a first conductive clip 632b disposed on a side of the first clip body 632a. The second discharge voltage applying portion 634 includes a second clip body 634a and a second conductive clip 634b disposed on a side of the second clip body 634a.

The first and second conductive clips 632b and 634b are combined with the voltage supplying unit 130 formed on the surface light source 100 to fix the surface light source 100.

The inverter 640 applies the discharge voltage to the first and second discharge voltage applying portions 632 and 634. The first discharge voltage applying portion 632 is electrically connected to the inverter 640 through a first conductive line 642. The second discharge voltage applying portion 634 is electrically connected to the inverter 640 through a second conductive line 644.

The LCD panel 700 converts a visible light generated from the surface light source 100 into an image light. The LCD panel 700 includes a thin film transistor (TFT) substrate 710, a color filter substrate 730, a liquid crystal 720 and a driving module 740.

The TFT substrate 710 includes a plurality of pixel electrodes (not shown) that are arranged in a matrix shape, a plurality of TFTs (not shown) that apply the driving voltage to the pixel electrodes (not shown), a gate line and a data line. Alternatively, the TFT substrate 710 may include a plurality of the data lines and a plurality of the gate lines.

The color filter substrate 730 includes a color filter (not shown) corresponding to the pixel electrodes (not shown) and a common electrode (not shown) disposed on the color filters (not shown). Alternatively, the color filter substrate 730 may include a plurality of the color filters (not shown).

The liquid crystal 720 is disposed between the TFT substrate 710 and the color filter substrate 730.

The chassis 800 surrounds side portions of the color filter substrate 730 of the LCD panel 700. A portion of the chassis 800 is hooked on the receiving container 600. The chassis 600 protects the LCD panel 700 from an impact that is provided from an exterior to the LCD apparatus 900. In addition, the chassis 600 prevents a drifting of the LCD panel 700 from the receiving container 600.

A light diffusion member 550 is disposed between the surface light source 100 and the LCD panel 700 to improve optical characteristics of the visible light generated from the surface light source 100. Optical sheets (not shown) may be disposed on the optical member 550. The optical sheets (not shown) may include a prism sheet, a diffusion sheet, etc. In addition, the optical sheets (not shown) may also include a retardation film, a polarization film, a reflective polarizing film, etc. Furthermore, a mold frame (not shown) may be disposed between the light diffusion member 550 and the surface light source 100 so that the light diffusion member 550 is spaced apart from the surface light source 100, thereby uniformizing a luminance of the visible light generated from the surface light source 100.

According to this exemplary embodiment, a surface light source includes a voltage supplying unit disposed on an outer surface of the surface light source and a conductive body disposed on an inner surface of the surface light source so that a luminance of a visible light generated from the surface light source is increased and the luminance of the visible light is uniformized. That is, the surface light source includes two types of electrodes that are disposed on the inner and outer surfaces of a body of the surface light source. In addition, a start voltage of the surface light source is decreased so that a power consumption of the surface light source may be decreased. Furthermore, plasma is uniformly distributed in discharge portions so that the luminance of the surface light source is uniformized, thereby improving an image display quality of a display apparatus having the surface light source.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. A surface light source comprising:
a body including a plurality of discharge portions;
a voltage supplying unit disposed on an outer surface of the body to generate an invisible light in the discharge portions;
a conductive body disposed on an inner surface of the body corresponding to the voltage supplying unit; and
a visible light generating part disposed in the discharge portions to generate a visible light based on the invisible light.

2. The surface light source of claim 1, further comprising a connecting portion that connects the discharge portions to one another.

3. The surface light source of claim 1, wherein each of the discharge portions is extended in a first direction, and the discharge portions are aligned in a second direction that is in substantially perpendicular to the first direction.

4. The surface light source of claim 1, wherein the voltage supplying unit comprises a first voltage supplying portion that is in substantially perpendicular to the discharge portions, and a second voltage supplying portion that is in substantially parallel with the first voltage supplying portion and spaced apart from the first voltage supplying portion.

5. The surface light source of claim 1, wherein the conductive body has substantially equal shape and size to the voltage supplying unit.

6. The surface light source of claim 1, wherein the visible light generating part comprises:
an operation gas that generates the invisible light in the discharge portions using an electric field formed by the voltage supplying unit; and
a fluorescent layer disposed in the body to convert the invisible light into the visible light.

7. The surface light source of claim 1, wherein the conductive body has a hole to increase an amount of a discharge current.

8. The surface light source of claim 7, wherein a plurality of holes is formed in the conductive body and each of the holes corresponds to each of the discharge portions.

9. The surface light source of claim 1, wherein the conductive body has a plurality of recesses to increase an amount of a discharge current, and each of the recesses corresponds to each of the discharge portions.

10. The surface light source of claim 4, wherein the conductive body comprises a plurality of first conductive portions spaced apart from one another and a plurality of second conductive portions spaced apart from one another, and the first and second conductive portions correspond to the first and second voltage supplying portions, respectively.

11. The surface light source of claim 10, wherein each of the first conductive portions corresponding to each of the discharge portions has a hole, and each of the second conductive portions corresponding to each of the discharge portions has a hole.

12. The surface light source of claim 10, wherein each of the first conductive portions corresponding to each of the discharge portions has a plurality of holes, and each of the second conductive portions corresponding to each of the discharge portions has a plurality of holes.

13. The surface light source of claim 4, wherein the conductive body comprises a first conductive portion corresponding to the first voltage supplying portion and a second conductive portion corresponding to the second voltage supplying portion, and the first and second conductive portions have substantially identical shape and size to the first and second voltage supplying portions, respectively.

14. The surface light source of claim 13, wherein a portion of each of the first conductive portions, which corresponds to each of the discharge portions, has a hole, and a portion of each of the second conductive portions, which corresponds to each of the discharge portions, has a hole.

15. The surface light source of claim 13, wherein a portion of each of the first conductive portions, which corresponds to each of the discharge portions has a plurality of holes, and a portion of each of the second conductive portions, which corresponds to each of the discharge portions, has a plurality of holes.

16. The surface light source of claim 1, further comprising a protecting layer disposed on the inner surface of the body to protect the body.

17. The surface light source of claim 1, further comprising a reflection layer disposed on the inner surface of the body so that the visible light is reflected from the reflection layer.

18. The surface light source of claim 1, wherein the body comprises:
a first substrate;
a second substrate corresponding to the first substrate;
a sealant disposed between a first peripheral region of the first substrate and a second peripheral region of the second substrate to form a discharge space having the discharge portions; and
a space dividing member disposed between the first and second substrates to divide the discharge space into the discharge portions.

19. The surface light source of claim 18, further comprising a reflection layer disposed on an upper surface of the second substrate so that the visible light is reflected from the reflection layer.

20. A surface light source comprising:
a body including a plurality of discharge portions having operation gas;
a voltage supplying unit disposed on an outer surface of the body to generate an electric field in the discharge portions;
a conductive body disposed on an inner surface of the body corresponding to the voltage supplying unit to supply the discharge portions with electrons based on the electric field; and
a fluorescent layer disposed in the discharge portions to convert an invisible light into a visible light, the invisible light being generated in the discharge portions by the operation gas and the electrons.

21. The surface light source of claim 20, further comprising a connecting portion that connects the discharge portions to one another.

22. The surface light source of claim 20, wherein the conductive body has a hole to increase an amount of a discharge current.

23. The surface light source of claim 20, wherein the conductive body comprises a plurality of conductive portions spaced apart from one another.

24. A display apparatus comprising:
a surface light source including a body having a plurality of discharge portions, a voltage supplying unit disposed on an outer surface of the body to generate an invisible light in the discharge portions, a conductive body disposed on an inner surface of the body corresponding to the voltage supplying unit, and a fluorescent layer to convert the invisible light into a visible light;
a display panel disposed on the surface light source to convert the visible light into an image; and
a receiving container that receives the surface light source and the display panel.

25. The display apparatus of claim 24, wherein the conductive body has a hole to increase an amount of a discharge current.

26. The display apparatus of claim 24, wherein the conductive body comprises a plurality of conductive portions spaced apart from one another.

27. A liquid crystal display apparatus comprising:
a surface light source including a body having a plurality of discharge portions, a voltage supplying unit disposed on an outer surface of the body to form an electric field in the discharge portions to generate an invisible light in the discharge portions, a conductive body disposed on an inner surface of the body corresponding to the voltage supplying unit, and a fluorescent layer disposed in the discharge portions to convert the invisible light into a visible light;
a liquid crystal display panel disposed on the surface light source to convert the visible light into an image, the liquid crystal display panel including a liquid crystal disposed between two substrates; and
a receiving container that receives the surface light source and the liquid crystal display panel.

28. The liquid crystal display apparatus of claim 27, wherein the body comprising:
a first substrate;
a second substrate corresponding to the first substrate;
a sealant disposed between a first peripheral region of the first substrate and a second peripheral region of the second substrate to form a discharge space having the discharge portions; and
a space dividing member disposed between the first and second substrates to divide the discharge space into the discharge portions.

29. The liquid crystal display apparatus of claim 28, further comprising a reflection layer disposed on an upper surface of the second substrate so that the visible light is reflected from the reflection layer.

30. The liquid crystal display apparatus of claim 28, wherein the conductive body has a hole or a recess corresponding to one of the discharge portions to increase an amount of a discharge current.
